(19) United States
(12) Patent Application Publication
(10) Pub. No.: US 2010/0250385 A1
(43) Pub. Date: Sep. 30, 2010

(54) METHOD AND SYSTEM FOR A COMBINATION VOUCHER

(76) Inventors: Eric Lempel, Hayward, CA (US); Jennifer Cho, Redwood City, CA (US); Paul Purdy, San Ramon, CA (US)

Correspondence Address: William S. Frommer, Esq.;c/o FORMMER LAWRENCE & HAUG LLP, 745 Fifth Avenue, New York, NY, 10151, US

(21) Appl. No.: 12/415,211

(22) Filed: Mar. 31, 2009

(51) Int. Cl. G06Q 30/00; G06F 21/00

(52) U.S. Cl. 705/26; 726/3; 705/1.1

(57) ABSTRACT

A voucher system for redeeming vouchers via a network. The voucher has an associated voucher code that permits access to one or more first items and/or one or more second items. A redemption module accepts a voucher code such that a user, upon validation of the voucher code, selects one or more of the first items and/or selects one or more of the second items. Upon redeeming the voucher, the user receives the selected first items at a designated user account and receives the selected second items at a designated user account.

### BACKGROUND

1. Field of the Invention

This invention relates generally to a method and system for providing a combination voucher. More specifically, the combination voucher may be redeemed for either monetary value and/or tangible articles and/or electronic representations of articles or any combination thereof.

2. Background Discussion

A voucher may be generally thought of a bond which is worth a certain monetary value and which may typically be spent for specific reasons or on specific goods. Examples may include housing, travel and food vouchers.

Product vouchers typically provide access to specific products that may be available to a user. Money vouchers may be used, for example, to entitle a holder to purchase items using the funds. For example, a person may redeem a voucher at a store and receive store credit for the amount of the voucher. A voucher may be in the form of a card that is sold at a retail store for a particular denomination or amount. A holder of the voucher may redeem the voucher for the amount of the voucher.

### SUMMARY

Embodiments of the present invention are directed to methods and apparatus for a voucher, coupon, certificate or other document (either tangible or an electronic representation), that may be redeemed for access to products, such as products that may be downloaded from a website and/or redeemed for electronic representations of items (virtual items) and/or redeemed for electronic funds, or digital money.

One embodiment of the present invention is directed to a voucher system for redeeming vouchers via a network. The system includes a voucher having an associated voucher code that permits access to one or more first items and/or one or more second items. A redemption module accepts a voucher code such that a user, upon validation of the voucher code, selects one or more of the first items and/or selects one or more of the second items or any combination thereof. Upon redeeming the voucher, the user receives the selected first items at a designated user account and/or receives the selected second items at a designated user account.

Another embodiment is directed to the voucher system described above in which the first items include electronic funds and/or one or more electronic representations of articles and/or one or more tangible articles.

Yet another embodiment is directed to the voucher system described above in which the digital funds are associated with a particular product.

Yet another embodiment is directed to the voucher system described above in which the second items include electronic articles and/or tangible articles and/or electronic funds.

Yet another embodiment is directed to the voucher system described above in which the electronic articles include one or more of predetermined video games, video game accessories, limited editions of video games, and video game and/or movie rentals.

Yet another embodiment is directed to the voucher system described above in which the voucher code is concealed until the code is accessed by an authorized user.

Yet another embodiment is directed to the voucher system described above in which the voucher code permits access to both first items and second items.

Yet another embodiment is directed to the voucher system described above in which the second items are associated with a predetermined vendor.

Yet another embodiment is directed to the voucher system described above in which the second items are associated with a specific product.

Yet another embodiment is directed to the voucher system described above in which the redemption module is a Playstation3™ terminal.

Yet another embodiment is directed to the voucher system described above in which the voucher code enables the user to access customized video content.

Other embodiments of the present invention include the methods described above but implemented using apparatus or programmed as computer code to be executed by one or more processors operating in conjunction with one or more electronic storage media.

### BRIEF DESCRIPTION OF THE DRAWINGS

To the accomplishment of the foregoing and related ends, certain illustrative embodiments of the invention are described herein in connection with the following description and the annexed drawings. These embodiments are indicative, however, of but a few of the various ways in which the principles of the invention may be employed and the present invention is intended to include all such aspects and their equivalents. Other advantages, embodiments and novel features of the invention may become apparent from the following description of the invention when considered in conjunction with the drawings. The following description, given by way of example, but not intended to limit the invention solely to the specific embodiments described, may best be understood in conjunction with the accompanying drawings, in which:

FIG. 1 illustrates a perspective view of a voucher according to an embodiment of the present invention;

FIG. 2 illustrates an example of a network in which vouchers may be generated and/or redeemed according to an embodiment of the present invention;

FIG. 3 illustrates an example of a processing apparatus that includes a voucher generation module, voucher redemption module and billing module according to an embodiment of the present invention;

FIG. 4 shows an example of an algorithm used to generate a voucher according to an embodiment of the present invention;

FIG. 5 shows an example of a menu screen to determine content of a voucher according to an embodiment of the present invention;

FIG. 6 shows an example of a display that may be used to generate a voucher according to an embodiment of the present invention;

FIG. 7 shows a series of steps that may be used to redeem a voucher according to an embodiment of the present invention;

FIG. 8 shows a menu display with selected voucher content for a user to choose;

FIG. 9 shows a billing algorithm according to an embodiment of the present invention; and

FIG. 10 shows an example of an electronic representation of a voucher according to an embodiment of the present invention.

### DETAILED DESCRIPTION

It is noted that in this disclosure and particularly in the claims and/or paragraphs, terms such as “comprises,” “comprised,” “comprising,” and the like can have the meaning attributed to it in U.S. patent law; that is, they can mean “includes,” “included,” “including,” “including, but not limited to” and the like, and allow for elements not explicitly recited. Terms such as “consisting essentially of” and “consists essentially of” have the meaning ascribed to them in U.S. patent law; that is, they allow for elements not explicitly recited, but exclude elements that are found in the prior art or that affect a basic or novel characteristic of the invention. These and other embodiments are disclosed or are apparent from and encompassed by, the following description. As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

Furthermore, the detailed description describes various embodiments of the present invention for illustration purposes and embodiments of the present invention include the methods described and may be implemented using one or more apparatus, such as processing apparatus coupled to electronic media. Embodiments of the present invention may be stored on an electronic media (electronic memory, RAM, ROM, EEPROM) or programmed as computer code (e.g., source code, object code or any suitable programming language) to be executed by one or more processors operating in conjunction with one or more electronic storage media.

As stated above, the present invention is directed to vouchers that may be redeemed for access to electronic funds and/or tangible articles (video games, CDs, DVDs, clothing) and/or virtual articles (virtual accessories) or a combination of electronic funds and tangible articles and virtual articles.

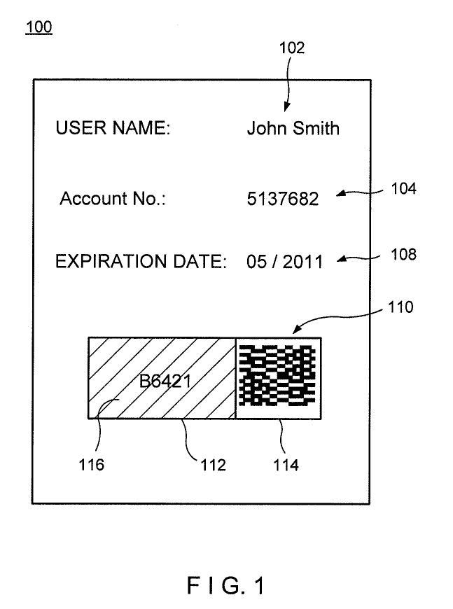

FIG. 1 illustrates a perspective view of a voucher 100 according to an embodiment of the present invention.

As shown in FIG. 1, an example of a voucher 100 identifies a user name 102 (John Smith), an Account No. 104 (5137682), an expiration date 108 (May 2011) and a voucher code 110.

Voucher 100 may take the form of a coupon, certificate, ticket or other document, which may be in a tangible form (e.g., plastic card) or an electronic representation that may be downloaded from a remote location, printed, or transmitted at a user terminal. Voucher 100 may be used as a prepaid voucher that may be redeemed to purchase items (e.g., video games, video game accessories or tangible articles) or redeemed for electronic funds to fund an online “wallet” in order to purchase content or goods without a credit card.

Vouchers, such as voucher 100, may be purchased at a retail or “point-of-sale” location such as Blockbuster™, Rite-Aid™, and 7-Eleven™ Wal-Mart™, Best Buy™, and Target™ stores. Alternatively, vouchers may be purchased via a network from a user terminal and accessed either at that user terminal and/or a remote user terminal.

User name 102 is used to identify a user or name of an account holder. Account number 104 is used to associate the account with a specific user and expiration 108 is used to identify an expiration date of the voucher. Voucher code 110 may include, for example, an alpha-numeric code portion 112 (B6421) or a barcode portion 114 or both an alpha-numeric code portion 112 (B6421) and a barcode portion 114. Both the alpha-numeric code portion 112 and barcode portion may be obscured with a covering layer 116. Alternatively, as shown in FIG. 1, only the alpha-numeric (e.g., human-readable) portion 112 may be obscured.

The covering layer 116 may be, for example, a “scratch-off” material, similar to those used in lottery tickets and other scratch-and-win type contests. The scratch-off layer 116 obscures the voucher code 110, which includes portions 112 and 114, from observation by both the voucher distributor and individuals who may see the voucher prior to purchase. This prevents unauthorized users from accessing the voucher and prevents access of the voucher until after the voucher has been sold. In this way, the voucher code 110 is secure. After the voucher 100 has been purchased or transmitted to a valid user, a user may scratch away the layer 116 to reveal the voucher code 110. This voucher code may entered into a user account, at a user terminal (such as home computer, PLAYSTATION™, or PSP™) to enable access to the voucher content. The bar code portion 114 may be scanned at a retail or point of sale location to enable the user to purchase merchandise associated with the voucher 100.

In an embodiment in which the voucher 100 is retrieved electronically (i.e., from a client or user terminal or PLAYSTATION™, or PSP™) the user may perform an electronic scratch-off operation that mimics a physical scratch-off action. This is described in more detail in relation to FIG. 10 herein.

The voucher code 110, once revealed, enables the authorized user to access both electronic funds and/or articles (either tangible articles or electronic representations of articles) at the same time using the single voucher code 110. Thus, generally, upon validation of the voucher code (either at a point of sale location or by entering the voucher code 110 into a user account on-line), a user selects one or more of a first item and/or selects one or more second items at substantially the same time (the user can access both types of items in the same session upon validation of the voucher code 110).

The first items and second items may include a monetary redemption value such as electronic funds, typically a specific monetary value, for example a purchaser goes to a store or other retail venue (physical or website), pays $50 (for example) and obtains a voucher with $50 to spend on designated merchandise. This merchandise may be, for example, video games, music, movies, CDs, DVDs, clothing, or gaming accessories (e.g., a controller, headphones, camera, etc.) that may be purchased online or in a physical store or retail location. Any merchandise that is available at the particular venue (physical or virtual (website) may be purchased using the voucher.

The first items and second items may also include non-monetary articles such as video games, music, movies, CDs, DVDs, bonus footage (outtakes, “behind-the scenes” footage, alternate endings, additional songs, interviews with the actors/directors/singers, bloopers etc.) plug-ins, plug-and-play, demo material, rental privileges, unlockable content, bundles of audio and video content (e.g., 2 movies and 3 music CDs), tangible accessories such as a portable battery pack, headphones or adapter or electronic (virtual) accessories such as accessories for an avatar (e.g., a sword for an avatar, clothing for an avatar), accessories for video games, virtual reality media (VRM) articles, and other virtual articles. These items may be purchased at a retail store outlet or retrieved via a user terminal such as downloading virtual articles from a website.

The use of electronic finds may facilitate a retailer to offer specific promotional programs in which a unique product would be available for downloading when purchasing or accessing a voucher from that specific retailer. A specific example is a BEST BUY™ store may offer a virtual yellow shirt similar to shirts worn by employees as an article to be redeemed with a voucher. This type of product could be associated with the voucher code 110 of voucher 100.

Any combination of first items and second items may be accessed by a voucher 100. The content associated with the voucher 100 (monetary value and/or articles (real or virtual)) is determined at the time the voucher is generated. Some examples of combination of items are described below.

For example the content of the voucher 100 may be a $20.00 monetary value and a video game such as KILLZONE™. The $20.00 worth of electronic funds may be placed into an online account of the user. These funds may then be saved in the account for use at a later time. The video game (KILLZONE™) may be obtained at a retail store location or online.

Another example of the redemption content of voucher 100 may be a $20.00 monetary value, in the form of electronic (digital) funds and a tangible article. The tangible article may be a retail-specific item such as a yellow BESTBUY™ shirt, similar to those worn by employees while working at the store. The shirt may be picked-up at the retail location or ordered on-line. For example, the tangible article (e.g., BESTBUY™ shirt) may be given to the voucher holder at one time (while the holder is at the store) and the electronic funds may be deposited into the user's account to be used at a time the user chooses.

Yet another example of the redemption content of the voucher 100 could be an amount of electronic funds ($20.00) and a virtual accessory such as a weapon to be used in a video game.

Yet another example of the redemption content of voucher 100 is a virtual accessory (e.g., a helmet for an avatar) and authorization to access a demo of a new, as yet unreleased, video game.

Yet another example of the redemption content of voucher 100 is a tangible accessory, such as a hat for the user, and a virtual accessory such as a hat (which may be matching style) for an avatar.

Yet another example of the redemption content of voucher 100 is electronic funds and bonus songs, such as unreleased or acoustic versions of one or more songs.

Yet another example of the redemption content of voucher 100 is a virtual weapon that may be used in a video game and additional video game content. The additional video game content may include in-game advertising content. This advertising content may be related to the virtual weapon and may advertise virtual accessories related to the virtual weapon.

Yet another example of the redemption content of voucher 100 is a version of a game that permits the user to win a virtual article, such as a particular hat/clothing item or weapon and a coupon to redeem the actual physical corresponding article or a virtual representation of the article. For example, voucher 100 may entitle a user could download a video game, during the course of which he/she won a baseball cap and the voucher 100 also provides a coupon for redeeming a physical baseball cap similar to the virtual baseball cap that was won by the user while playing the game.

Yet another example of the redemption content of voucher 100 is electronic funds and rental privileges for a selected quantity and/or type of movie rentals. Specifically, $10.00 worth of electronic funds and 5 movie rentals with a “PG” rating.

Yet another example of the redemption content of voucher 100 is electronic funds and unlockable footage for a video game. The unlockable footage may entitle the user to specific accessories which can be purchased with the electronic finds.

Yet another example of the redemption content of voucher 100 is electronic funds and a preselected menu of video games that the user may select from. Specifically, the user may see a menu of 10 video game titles and may select any two video games.

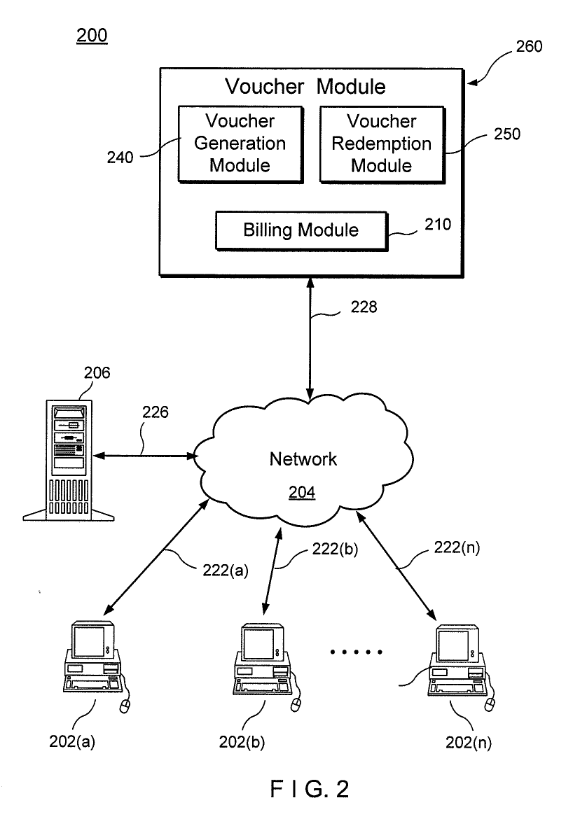

FIG. 2 illustrates an example of a network 200 in which vouchers may be generated and/or redeemed according to an embodiment of the present invention.

Embodiments of the present invention may be implemented using one or more processing devices, or processing modules. The processing devices, or modules, may be coupled such that portions of the processing and/or data manipulation may be performed at one or more processing devices and shared or transmitted between a plurality of processing devices. For example, a voucher, as shown in FIG. 1, may be generated by a user at one location and accessed at another location, by that user or another user.

Thus, an example of the invention is described in a network environment. Specifically, FIG. 2 shows a network environment 200 adapted to support various embodiments of the present invention. The exemplary environment 200 includes a network 204, a voucher module, or facility 260. (A module, as used herein, is for example, a series of instructions stored on a computer-readable, or an electronic storage medium storing program code, or a memory unit storing instructions that is coupled to an associated dedicated processing unit for execution of the instructions, the module may be a plugin unit, stand alone set of instructions, or program code or may be an integral part of a larger component. Each module may be stored in a separate memory or a common computer memory.) FIG. 2 also show a plurality of terminals 202(a) . . . 202(n), where “n” is any suitable number and a kiosk 206.

The network 204 is, for example, any combination of linked computers, or processing devices, adapted to transfer and process data. The network 204 may be private Internet Protocol (IP) networks, as well as public IP networks, such as the Internet that can utilize World Wide Web (www) browsing functionality. An example of a wired network is a network that uses communication busses and MODEMS, or DSL lines, or a local area network (LAN) or a wide area network (WAN) to transmit and receive data between terminals. An example of a wireless network is a wireless LAN. Global System for Mobile Communication (GSM) is another example of a wireless network. The GSM network is divided into three major systems which are the switching system, the base station system, and the operation and support system (GSM). Also, IEEE 802.11 (Wi-Fi) is a commonly used wireless network in computer systems which enables connection to the Internet or other machines that have Wi-Fi functionality. Wi-Fi networks broadcast radio waves that can be picked up by Wi-Fi receivers that are attached to different computers.

Voucher module, or facility 260 includes a billing module 210, voucher generation module 240 and voucher redemption module 250. The voucher module 260 may be for example a server computer operatively connected to network 204, via bi-directional communication channel, or interconnector, 228, which may be for example a serial bus such as IEEE 1394, or other wire or wireless transmission medium. The terms “operatively connected” and “operatively coupled”, as used herein, mean that the elements so connected or coupled are adapted to transmit and/or receive data, or otherwise communicate. The transmission, reception or communication is between the particular elements, and may or may not include other intermediary elements. This connection/coupling may or may not involve additional transmission media, or components, and may be within a single module or device or between the remote modules or devices.

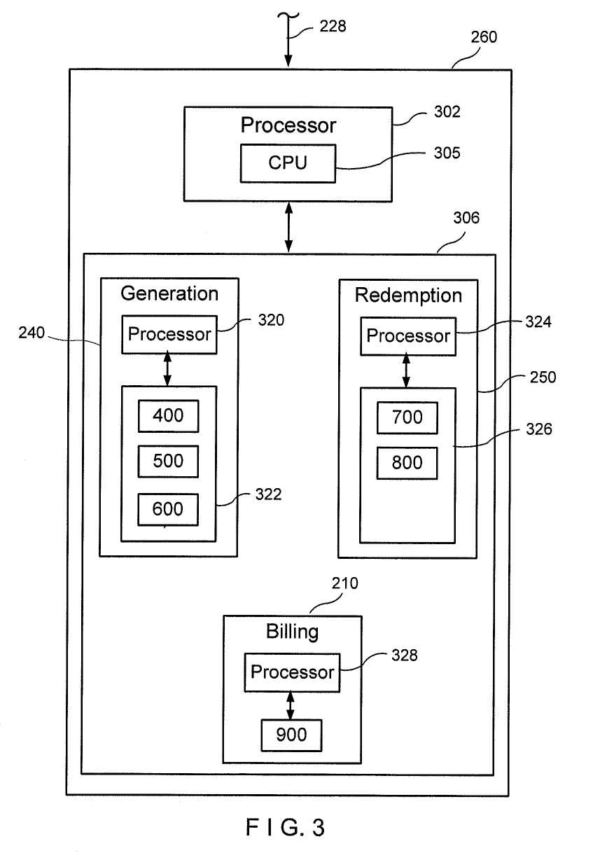

The voucher module 260 is adapted to transmit data to, and receive data from, terminals 202(a) . . . (n) and kiosk 206, via the network 204. Voucher module 260 is described in more detail with reference to FIG. 3, herein.

Terminals 202(a) . . . (n) (where “n” is any suitable number) (generally referred to as 202) are coupled to network 204 via an associated bi-directional communication medium 222(a) . . . (n), which may be for example a serial bus such as IEEE 1394, or other wire or wireless transmission medium. Terminals 202 may be communication appliances, or user locations, or subscriber devices, or client terminals. For example, terminals 202 may be computers, or other processing devices such as a desktop computer, laptop computer, personal digital assistant (PDA), wireless handheld device, PLAYSTATION™ , PSP™ and the like. They may be capable of processing and storing data themselves or merely capable of accessing processed and stored data from another location (i.e., both thin and fat terminals).

Terminal 202(a) may be a user terminal at which a user receives a voucher that was specified, or ordered at a different terminal (e.g., terminal 202(b)). Alternatively, terminal 202(n) may be a terminal at a retail store location at which a user specifies a voucher that is to be accessed at a different terminal (i.e., 202(a) and/or 202(b)). Kiosk 206 is also adapted and capable of specifying a voucher that may be accessed at another terminal (e.g. 202(a)). A user may also access a voucher at kiosk 206. The kiosk 206 is coupled to network 204 via bi-directional communication medium 226.

Terminals 202 typically include a display unit and an input unit. The display unit is used to display the data generated by the system 200 as well as input generated at the terminal 202, and the voucher generated by voucher module 260. The display unit of terminal 202 may be, for example, a monitor, LCD (liquid crystal display), a plasma screen, a graphical user interface (GUI) or other unit adapted to display output data typically by a representation of pixels to form text and graphic and video date. The input unit may include devices such as a keyboard, mouse, track ball and/or touch pad or any combination thereof.

The voucher module 260 and terminals 202 and kiosk 206 typically utilize a network service provider, such as an Internet Service Provider (ISP) or Application Service Provider (ASP) (ISP and ASP are not shown) to access resources of the network 204.

FIG. 3 illustrates an example of voucher module 260 that includes a processor module 302, a memory module 306, a voucher generation module 240, a voucher redemption module 250, and a billing module 210. Voucher module 260 is coupled to network (204 in FIG. 1) via bi-direction communication medium 228.

Processor module 302 is coupled to voucher generation module 240, voucher redemption module 250, and billing module 210 via an associated communication link to enable processor module 302 to coordinate processing operations of the modules. The processor module 302 includes a CPU 305, which is typically a processor that includes an arithmetic logic unit (ALU), which performs arithmetic and logical operations, and a control unit (CU), which extracts instructions from memory and decodes and executes them, utilizing the ALU when necessary. An I/O interface may be used to operatively couple the components of processor module 302.

Memory 306 stores programs, which include, for example, a web browser, algorithms, as well as typical operating system programs (not shown), input/output programs (not shown), and other programs that facilitate operation of server voucher module 260. The web browser (not shown) is for example an Internet browser program such as Internet Explorer™. Memory module 305 may be, for example, an electronic storage medium, such as an other electronic storage repository that can store data used by voucher module 260. The memory module 306 may include, for example, RAM, ROM, EEPROM or other memory media, such as an optical disk, optical tape, CD, or a floppy disk, a hard disk, or a removable cartridge, on which digital information is stored in the form of bits. The memory module 306 may also be remote memory coupled to processing module 302 via wired or wireless bi-directional communication medium.

Voucher generation module 240 includes a dedicated processor 320 and memory 322 which includes memory or storage locations 400 and 500, which are used to store generation algorithms and/or generation program code that may be stored on an electronic and/or computer-readable medium and executed by one or more processors to generate a voucher according to embodiments of the present invention and/or generate a display.

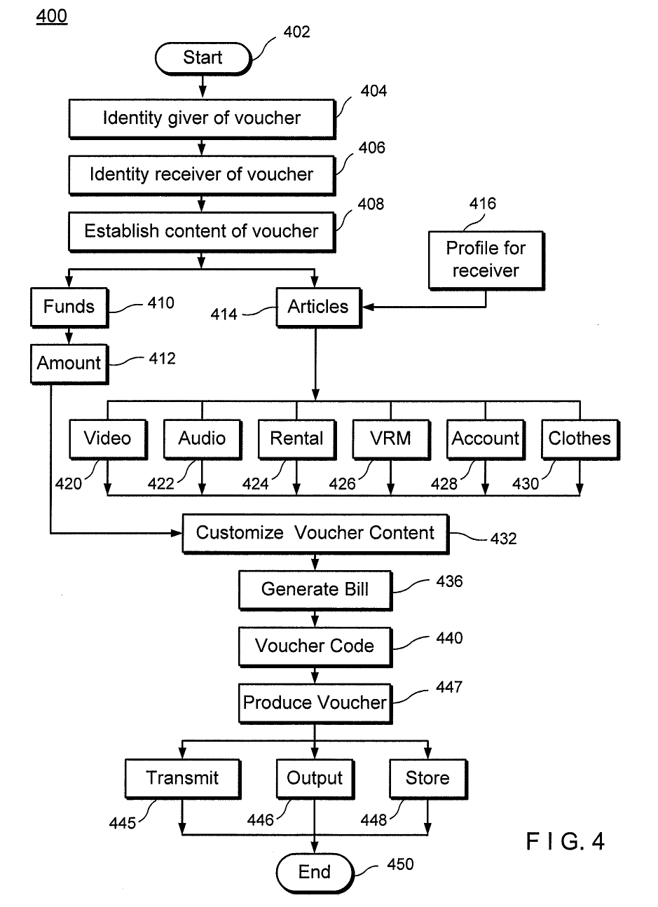

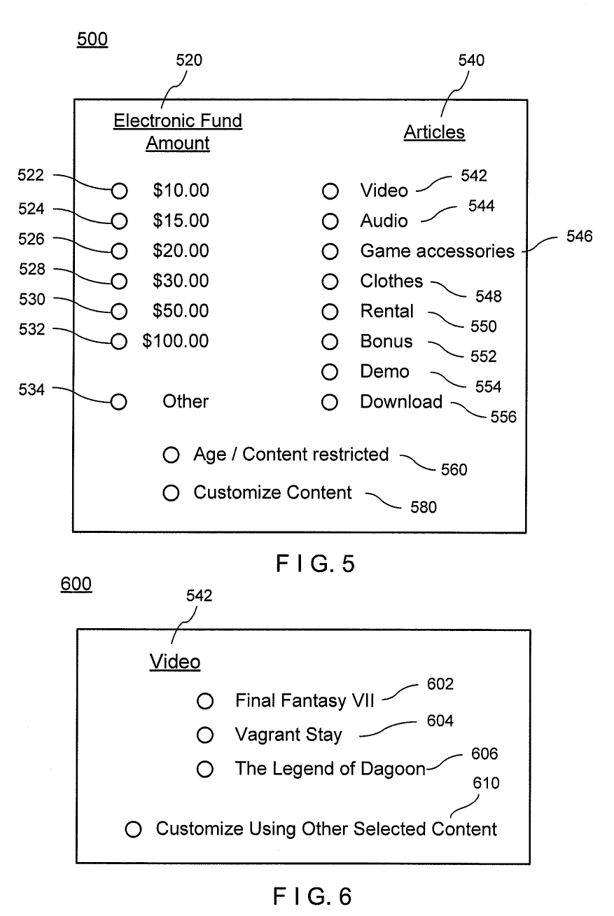

Algorithm 400 is described in relation to FIG. 4 and output displays 500 and 600 are described in relation to FIG. 5 and FIG. 6, respectively.

The voucher generation module 240 is adapted to receive input from a user, typically utilizing a terminal (shown as element 202 in FIG. 1), or kiosk (shown as element 206 in FIG. 1), as described herein, that represents content for a voucher to be generated and provided for redemption. The user who specifies a voucher may be considered a “giver” who requests a voucher for another, typically considered a “receiver”. The giver is provided with a menu of options to select from to form the content of the voucher. The content of the voucher may be electronic funds, and/or electronic representations of articles (virtual articles) and/or tangible articles (actual articles). This is described in more detail with relation to FIGS. 4, 5 and 6 herein. The giver can select desired content at a kiosk (206) or retail terminal (202(n)) or other terminal (202(b) or 202(c)).

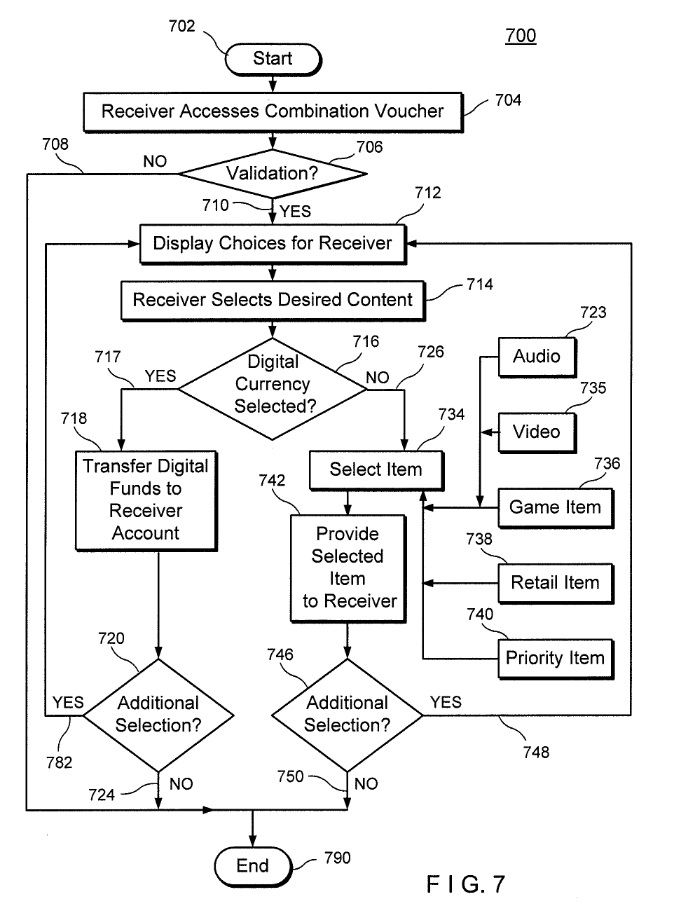

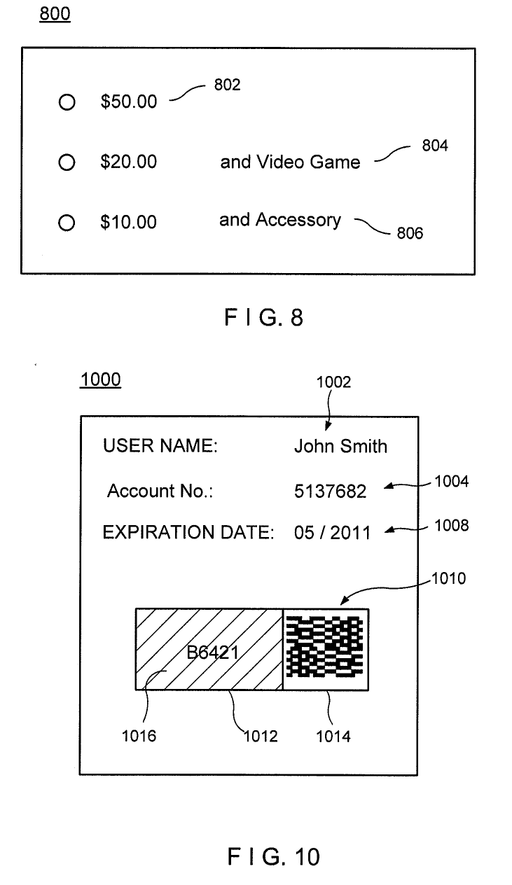

Voucher redemption module 250 includes a dedicated processor 324 memory module 326 that includes storage locations 700 and 800, which are used to store redemption algorithms and/or redemption program code that may be stored on an electronic and/or computer-readable medium and executed by one or more processors to redeem a voucher according to embodiments of the present invention. Algorithm 700 is described in relation to FIG. 7 and output display 800 is described in relation to FIG. 8. The voucher redemption module 250 receives a voucher code, typically from a receiver, and confirms that the voucher code is valid. If so, the voucher redemption module 250 correlates the voucher code to the content and provides an interface for the user to redeem the voucher.

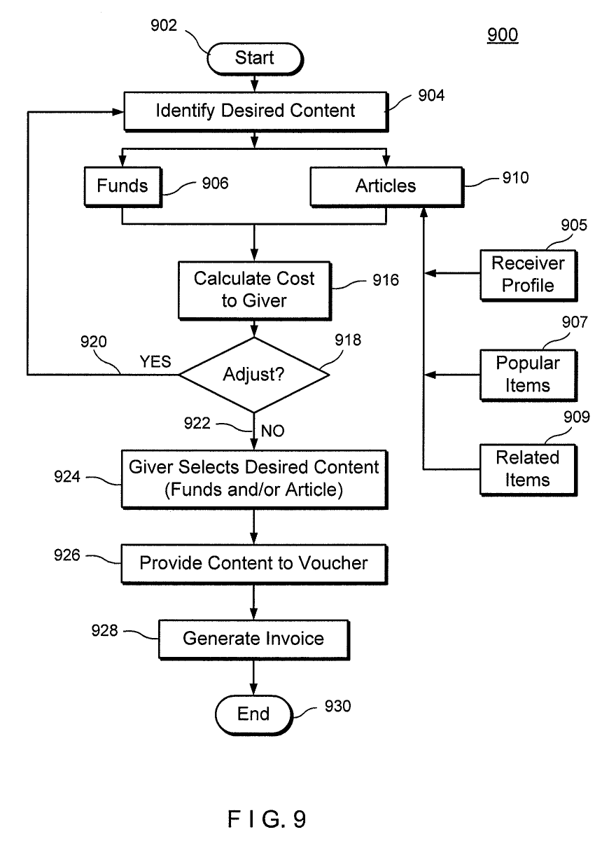

Billing module 210 includes dedicated processor 328 and memory 900 used to store a billing algorithm 900. Billing algorithm 900 is described in more detail in relation to FIG. 9 herein.

FIG. 4 shows an example of an algorithm used to generate a voucher according to an embodiment of the present invention. As shown in FIG. 4, the algorithm may be illustrated as a flowchart of steps 400 to implement an embodiment of the present invention. The steps 400 may be executed by a processor, or otherwise executed to perform the identified functions and may also be stored in one or more memories and/or one or more electronic and/or computer-readable media. For example, the steps of FIG. 4 may be stored on a computer-readable medium, such as ROM, RAM, EEPROM, CD, DVD, or other non-volatile memory. The program code stored on an electronic memory medium is a structural element. The process 400 begins with start step 402.

An identification of the “giver” or person requesting or specifying the voucher is established, as shown in step 404. An identification of a “receiver” or person receiving the voucher is established as shown in step 406.

Content of the voucher is determined, as shown in step 408. The voucher content may include electronic funds, as shown in step 410, and/or articles, as shown in step 414.

The funds, which are typically electronic funds or digital funds or other representation of a currency that may be used to purchase predetermined type of goods, may be specified to be a particular amount, as shown in step 412.

The giver may also select one or more virtual and/or one or more tangible articles to be included on the voucher, as shown in step 414. When articles are selected, a determination of whether the receiver has a profile, or list of desired articles, may be accessed, as shown in step 416. These articles could be game accessories for a favorite game, desired clothing to be worn, desired videos, desired CDs and other articles that relate to the receiver's activity. In the event a receiver has a profile, or list of desired items, those may be used to populate a menu of possible articles for the giver to select from when establishing the content of the voucher.

The articles that may be used as content for the voucher include, for example, videos (step 420), audio (step 422), rentals (step 424), virtual reality media (VRM) (step 426), accessories (step 428), clothing (step 430) or substantially any other article that may be redeemed.

Step 432 shows that the content that corresponds to the voucher may be customized. For example when video content (420) is selected, the video content may be edited based on other selections. For example, if an accessory, such as a sword (accessory 428) is selected the video (420) may be edited, or customized to include the accessory (sword). Thus, the voucher provides video content that is dynamically edited based on other voucher content.

Similarly, the content may be customized to include the ability for a user to spend the funds (412) on an accessory (428) shown in the video (420).

Once the voucher content has been established, a fee, or bill for the voucher is generated, as shown in step 436. Thus, the giver is notified of the amount the voucher cost. The bill, or invoice may be printed, emailed, stored or otherwise transferred. (Typically, the billing module 210 will be used for generating the bill or invoice, as described in relation to FIG. 9.)

A voucher code is generated that associates the voucher content, as shown in step 440. For example, the voucher code may be associated with a particular receiver. Alternatively, a voucher code may merely identify the voucher content and be used by any person who obtains the voucher code.

A voucher is produced as shown in step 444. This voucher may be transmitted electronically to an email address, or other terminal (step 445), and/or output, such as printed (step 446) and/or stored in a memory location, either at the voucher module 260 or other remote memory location (step 448).

The steps end as shown in step 450.

FIG. 5 shows an example of a menu display 500 to determine content of a voucher according to an embodiment of the present invention. Menu 500 may be displayed at a terminal (shown as element 202 in FIG. 1) display unit. (The menu display 500 may be generated for example by step 408 as shown in FIG. 4 during the determination of content for the voucher.) The menu identifies a list of fund amounts 520 and a list of articles 540. The funds 520 include various denominations: $10.00 (522); $15.00 (524); $20.00 (526); $30.00 (528); $50.00 (530); $100.00 (532) and other (534). The amount of funds desired to be placed on the voucher may be selected by the giver.

The articles 540 include: videos (542); audio (544); game accessories (546); clothes (548); rental (550); bonus (552); demo (554) and downloads (556). Each category of articles 540 has a subset, as shown, for example in FIG. 6.

The content selected by the giver is the content that may be redeemed by the receiver. However, as described in relation to FIG. 8, a voucher, generated based on the giver's selection, may provide the receiver with a choice of articles and various combinations of finds and articles. Thus, the giver may select to give a voucher that the receiver may redeem for a certain amount of funds or funds and accessories or finds and video games.

FIG. 5 also shows that the giver may restrict the possible content that the receiver may redeem the voucher for. For example, as shown by menu selection button 560, the giver can prevent mature content from being redeemed by the recipient.

Furthermore, the giver can choose to customize content based on selected voucher content. For example, if a recipient redeems the voucher for certain video content that is downloaded, the downloaded version may have customized content based on other redeemed content. Specifically, when a user redeems the voucher for an accessory such as sword, the downloaded content includes the sword. The giver uses menu button 580 to customize the voucher content.

FIG. 6 shows an example of a display 600 that may be used to generate a voucher including video games according to an embodiment of the present invention. Display 600 may be accessed by the giver selecting video content (selection button 542 in FIG. 5). The video content 542 includes, for example, various video games that may be selected as content for the voucher. As shown in FIG. 6, these include FINAL FANTASY VIII™ (602); VAGRANT STORY™ (604); and THE LEGEND OF DRAGOON™ (606). While three examples are shown, virtually any number of selection options may be displayed. As stated previously the voucher may include both electronic funds and/or tangible items and/or virtual items. Furthermore, menu selection 610 may be used to select customized content based on the other voucher content.

FIG. 7 shows a series of steps that may be used to redeem a voucher according to an embodiment of the present invention. As shown n FIG. 7, the series of steps may be represented as a flowchart 700 that may be executed by a processor, or otherwise executed to perform the identified functions and may also be stored in one or more memories and/or one or more electronic and/or computer-readable media. For example, the steps of FIG. 7 may be stored on a computer-readable medium, such as ROM, RAM, EEPROM, CD, DVD, or other non-volatile memory. The program code stored on an electronic memory medium is a structural element. The process 700 begins with start step 702.

A receiver accesses the voucher, typically after receiving the voucher (tangible) or notification of the voucher (electronic version), as shown in step 704. The receiver inputs the voucher code, which is validated, as shown in step 706. If the voucher code is not valid, as shown by “no” line 708, end step 790 is reached. If the voucher code is valid, “yes” line 710 shows that choices of possible articles are displayed to the receiver, as shown in step 712. Typically this choice menu is displayed at a terminal (i.e., element 202 of FIG. 1) or a kiosk (i.e., element 206 of FIG. 1). The receiver selects desired items, as shown in step 714.

For example, the receiver, or recipient, may have an option to select digital currency, as shown in step 716. If so, “yes” line 717 leads to transferring the electronic funds to an account associated with the receiver, as shown in step 718. Step 720 determines if the receiver has an additional selection. If so, “yes” line 782 leads back to step 712 that displays the choices to the receiver. The receiver may select items during the additional selection. Thus, a receiver can select both electronic finds and items, provided both are associated with the voucher code

If no additional selections are available. “no” line 724 leads to end step 790.

If digital currency is not selected, in step 716, the user may select items associated with the voucher code, as shown in step 734. (Reached via “no” line 726.) The available items may include items such as: video games (735); game accessories, real or virtual (736); audio content (CDs, albums, soundtracks) (733); retail items (shirts, hats, clothing) (738); and priority items, that may be of special interest to the receiver based on the receiver's profile (740).

Once the items are selected, they are provided to the receiver (recipient), either by downloading or delivery of the physical item, as shown in step 742. A determination is made as to whether any additional selection is available to the receiver, as shown in step 746. If so, “yes” line 748 shows that step 712 is reached, which displays remaining choices to the receiver. If there are no more available choices, then “no” line 750 leads to end step 790.

As shown in FIG. 7, a receiver can select both electronic funds and items, (real and/or virtual) provided the content is associated with the voucher code. The receiver can select as much money and/or as many items as the voucher is associated with.

FIG. 8 shows a menu display 800 with selected voucher content for a user to choose. For example, the voucher may be redeemed for $50.00 of electronic finds, as shown by 802. Alternatively, the voucher may be redeemed for $20.00 of electronic funds and video games, as shown by 804. The video games may be pre-selected as a particular video game or the receiver may have a list of possible video games to select from. Alternatively, the voucher may be redeemed for $10.00 in electronic funds and accessories, as shown by 806. The accessories may be pre-selected as a particular accessory or the receiver may have a list of possible accessories to select from.

FIG. 9 shows a billing algorithm 900 according to an embodiment of the present invention. As shown in FIG. 9, the algorithm may be represented as a series of steps that may be used to generate a bill or invoice for a voucher according to an embodiment of the present invention. FIG. 9 shows a flowchart of steps 900 that may be executed by a processor, or otherwise executed to perform the identified functions and may also be stored in one or more memories and/or one or more electronic and/or computer-readable media. For example, the steps of FIG. 9 may be stored on a computer-readable medium, such as ROM, RAM, EEPROM, CD, DVD, or other non-volatile memory. The program code stored on an electronic memory medium is a structural element.

The process 900 begins with start step 902. An identification of items desired for the voucher is shown in step 904. The items may be selected from a menu that includes first items (funds 906) and second items (articles (tangible and/or virtual) 910). The menu may be populated based on all available items, items related to a receiver profile (905), popular items (907) and items related to other selected items (909).

The cost of the voucher, including a total of items selected and funds selected is calculated, as shown in step 916. The giver is provided an opportunity to add more items and/or funds or decrease the amount of items and/or funds, thereby adjusting the cost of the voucher, as shown in step 918 and “yes” line 920, which leads back to the identification step. The billing algorithm 900 may be used to display to a giver the amount of money the voucher is going to cost prior to finalizing the voucher. Thus, as shown in step 918, the amount of money that the voucher will cost can be increased or decreased

When the cost of the voucher is acceptable, the giver finalizes the selection of the funds and/or items, as shown in step 924. The content of the voucher is associated with the voucher (voucher code), as shown in step 926. An invoice for the cost of the voucher is generated as shown in step 928. The invoice may be printed (output); stored or emailed to an electronic address. Also, the giver may pay with a credit card, debit card or other electronic payment method. End step 930 is then reached.

FIG. 10 shows an example of an electronic representation of a voucher 1000 according to an embodiment of the present invention. The electronic voucher 1000 may be emailed to a desired terminal (for example, terminal 202 or kiosk 206 as shown in FIG. 1) and displayed to a user. The electronic voucher 1000 may have an electronic scratch-off portion 1016 that a user may “scratch-off” using an input such as a mouse, track ball, keyboard to provide the user with the experience of scratching-off the electronic obscuring layer. 1016 to reveal the voucher code 1012. User name (1002), Account Number 1004, Expiration Date 1008 and barcode 1014 are also shown in FIG. 10.

It will be appreciated from the above that the invention may be implemented as computer software, which may be supplied on a storage medium or via a transmission medium such as a local-area network or a wide-area network, such as the Internet. It is to be further understood that, because some of the constituent system components and method steps depicted in the accompanying Figures can be implemented in software, the actual connections between the systems components (or the process steps) may differ depending upon the manner in which the present invention is programmed. Given the teachings of the present invention provided herein, one of ordinary skill in the related art will be able to contemplate these and similar implementations or configurations of the present invention.

It is to be understood that the present invention can be implemented in various forms of hardware, software, firmware, special purpose processes, or a combination thereof. In one embodiment, the present invention can be implemented in software as an application program tangible embodied on a computer readable program storage device. The application program can be uploaded to, and executed by, a machine comprising any suitable architecture.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

What is claimed is:

1. A voucher system for redeeming vouchers via a network, comprising:
a voucher having an associated voucher code,
wherein the voucher code permits access to one or more first items and/or one or more second items; and
one or more redemption modules adapted to utilize the voucher code such that a user, upon validation of the voucher code, selects one or more of the first items and/or selects one or more of the second items,
wherein upon redeeming the voucher, the user receives the selected first items at a designated user account and/or receives the selected second items at a designated user account.

2. The voucher system as claimed in claim 1, wherein the first items include electronic funds and/or one or more electronic representations of articles and/or one or more tangible articles.

3. The voucher system as claimed in claim 2, wherein the digital funds are associated with a particular product.

4. The voucher system as claimed in claim 1, wherein the second items include an electronic article and/or electronic funds.

5. The voucher system as claimed in claim 4, wherein the electronic article includes one or more of predetermined video games, video game accessories, limited editions of video games, and video game rentals.

6. The voucher system as claimed in claim 1, wherein the voucher code is concealed until the code is accessed by an authorized user.

7. The voucher system as claimed in claim 1, wherein the voucher code permits access to both first items and second items.

8. The voucher system as claimed in claim 1, wherein the second items are associated with a predetermined vendor.

9. The voucher system according to claim 1, wherein the second items are associated with a specific product.

10. The voucher system according to claim 1,
wherein the redemption module is a Playstation3 terminal.

11. The voucher system according to claim 1, wherein the voucher code enables the user to access customized video content.

12. A method for generating a voucher comprising:
identifying a voucher provider;
establishing content of the voucher based on selections by the voucher provider;
modifying a first portion of the content of the voucher based on a second portion of the content of the voucher;
generating a voucher code associated with the first portion of the content and the second portion of the content; and
generating a voucher having the voucher code.
